(19) United States
(12) Patent Application Publication
(10) Pub. No.: US 2005/0064377 A1
(43) Pub. Date: Mar. 24, 2005

(54) Toilet training doll system and device

(76) Inventor: Dea L. Whitfield, Oak Park, IL (US)

Correspondence Address: Dea L. Whitfield, 922 North Blvd Apt. 401, Oak Park, IL, 60301, US

(21) Appl. No.: 10/665,246

(22) Filed: Sep. 20, 2003

(51) Int. Cl. G09B 9/00

(52) U.S. Cl. 434/247

(57) ABSTRACT

The invention is a toilet training doll system and device for assisting an adult to training a toddler to use a toilet.

### TECHNICAL FIELD OF THE INVENTION

The invention relates to dolls, and, more particularly, the invention relates to toilet training dolls.

### STATEMENT OF A PROBLEM ADDRESSED BY THIS INVENTION

Interpretation Considerations

This section describes the technical field in more detail, and discusses problems encountered in the technical field. This section does not describe prior art as defined for purposes of anticipation or obviousness under 35 U.S.C. section 102 or 35 U.S.C. section 103. Thus, nothing stated in the Statement of a Problem Addressed by This Invention is to be construed as prior art.

Discussion

Toilet training a toddler can be a very time consuming and daunting task. Foremost, training a toddler to notify an adult when they have to urinate or defecate so that they can be taken to a restroom is mostly dependent on the toddler's discomfort level with a soiled diaper. In most instances, toddlers find a soiled diaper uncomfortable and the problem is overcome by the age of 3 years.

Secondary, training a toddler to use a toilet when they have to urinate or defecate is mostly dependent on an adult demonstrating how to properly use a toilet. In most instances, an adult will attempt to demonstrate the process of using a toilet by through verbal explanation. In other instances, an adult will attempt to demonstrate this process through pictures in a “potty” book or by manually manipulating a “potty” doll to simulate the using of a toilet. In yet fewer instances, adults will demonstrate themselves using the potty in front of a toddler.

Unfortunately, regardless of the method may adults find it difficult to toilet train a toddler. Similarly, adults find it difficult to find effective training means that are both educational and fun. Accordingly, there is benefit to be realized by making it easier to toilet train a toddler, such that the method is both educational and fun.

### BRIEF DESCRIPTION OF THE DRAWINGS

Various aspects of the invention, as well as at least one embodiment, are better understood by reference to the following EXEMPLARY EMBODIMENT OF A BEST MODE. To better understand the invention, the EXEMPLARY EMBODIMENT OF A BEST MODE should be read in conjunction with the drawings in which:

FIG. 1 illustrates drawings and a block diagram of a toilet training doll system;

FIG. 2 illustrates drawings and a block diagram of a configured doll system;

FIG. 3 illustrates drawings and a block diagram of a configured doll pant lowering, bending, and seating method.

### AN EXEMPLARY EMBODIMENT OF A BEST MODE

Interpretation Considerations

When reading this section (An Exemplary Embodiment of a Best Mode, which describes an exemplary embodiment of the best mode of the invention, hereinafter “exemplary embodiment”), one should keep in mind several points. First, the following exemplary embodiment is what the inventor believes to be the best mode for practicing the invention at the time this patent was filed. Thus, since one of ordinary skill in the art may recognize from the following exemplary embodiment that substantially equivalent structures or substantially equivalent acts may be used to achieve the same results in exactly the same way, or to achieve the same results in a not dissimilar way, the following exemplary embodiment should not be interpreted as limiting the invention to one embodiment.

Likewise, individual aspects (sometimes called species) of the invention are provided as examples, and, accordingly, one of ordinary skill in the art may recognize from a following exemplary structure (or a following exemplary act) that a substantially equivalent structure or substantially equivalent act may be used to either achieve the same results in substantially the same way, or to achieve the same results in a not dissimilar way.

Accordingly, the discussion of a species (or a specific item) invokes the genus (the class of items) to which that species belongs as well as related species in that genus. Likewise, the recitation of a genus invokes the species known in the art. Furthermore, it is recognized that as technology develops, a number of additional alternatives to achieve an aspect of the invention may arise. Such advances are hereby incorporated within their respective genus, and should be recognized as being functionally equivalent or structurally equivalent to the aspect shown or described.

Second, the only essential aspects of the invention are identified by the claims. Thus, aspects of the invention, including elements, acts, functions, and relationships (shown or described) should not be interpreted as being essential unless they are explicitly described and identified as being essential. Third, a function or an act should be interpreted as incorporating all modes of doing that function or act, unless otherwise explicitly stated (for example, one recognizes that “tacking” may be done by nailing, stapling, gluing, hot gunning, riveting, etc., and so a use of the word tacking invokes stapling, gluing, etc., and all other modes of that word and similar words, such as “attaching”). Fourth, unless explicitly stated otherwise, conjunctive words (such as “or”, “and”, “including”, or “comprising” for example) should be interpreted in the inclusive, not the exclusive, sense. Fifth, the words “means” and “step” are provided to facilitate the reader's understanding of the invention and do not mean “means” or “step” as defined in §112, paragraph 6 of 35 U.S.C., unless used as “means for—functioning—” or “step for—functioning—” in the Claims section.

Discussion of the Figures

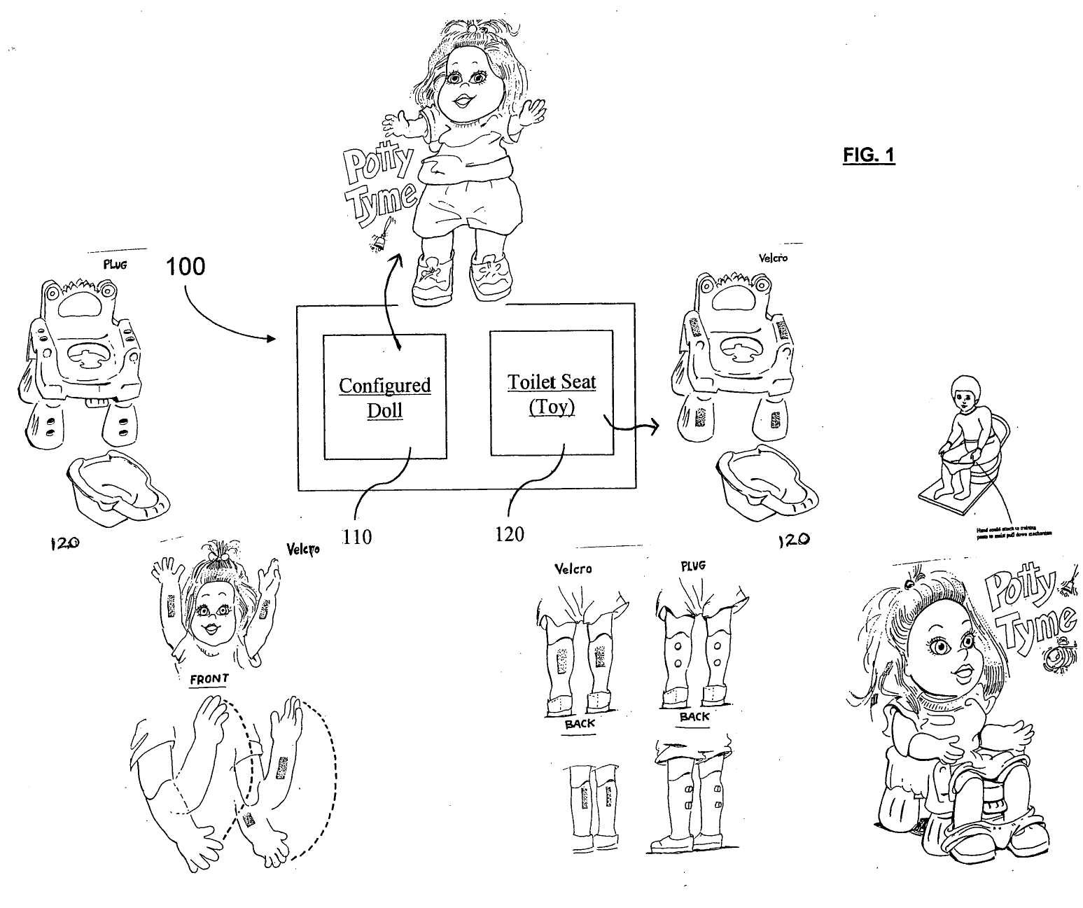

Features and advantages of the invention can be better understood by reviewing FIG. 1, which illustrates drawings and a toilet training doll system 100. The system 100 comprises a configured doll 110 and a toilet seat 120. Preferably, the toilet training doll system 100 is embodied as two separate toys that when united demonstrate to a toddler how to properly use a toilet. In an alternative embodiment, the system 100 may be embodied as single toy, wherein a portion of the configured doll 120 is integrally formed within a portion of the toilet seat 120 or other portion of a toilet having a toilet seat 120. In yet another embodiment, the system 100 may be embodied as two separate toys that are coupled together by a generally planar surface, representing a bathroom floor, for example, that is integrally formed within the lower most portion of the configured doll 110, the base of the configured dolls feet, for example, and the lower most portion of the toilet the toilet base, having a toilet seat 120. Lastly, the configured doll 110 may be embodied as a device that may be interoperable with a standard sized toilet seat or preferably, a toddler sized or doll sized toilet seat.

It is apparent to those skilled in the art of toy making that the configured doll 110 may be removably attached to the toilet seat 120 via a fastening means such as Velcro, plug, a clip, or snap, for example. In addition, it is also apparent, that the generally planar surface may be removably attachable to a portion of the configured doll 110 and to a portion of the toilet seat 120, via Velcro, plug, double stick tape, or other form of adhesive like material, for example.

In a preferred embodiment, the configured doll 110 is comprised of a plastic like material and is not gender specific. In addition, at a minimum the configured doll 110 is enabled to wear an under pant garment such as underwear, training pants, or a diaper, for example. Similarly, the configured doll 110 may have human like features to include, but not limited to, hair, a set of eyes, a nose, a mouth, two arms having hands, and two legs having feet. Accordingly, the doll may be embodied as a small child and be similar in size and height. It is also apparent to those skilled in the art of doll and or toy making that the configured doll 110 may have interchangeable parts that allow it to be gender specific, such as hair, clothing, or genitals, for example.

In a preferred embodiment, the toilet seat 120 is sized for the configured doll 110, however, in an alternative embodiment, the toilet seat 120 may be sized for a toddler. Preferably, the configure doll 120 will removably attach to a portion of the toilet seat, via a fastening means. It is apparent, however, that the toilet seat 120 may be removably attached to toilet bowl in one embodiment. In alternative embodiments, the toilet seat 120, may be integrally formed within the top surface of the toilet bowl, or may be permanently attached to a portion of the toilet bowl, or the toilet bowl and toilet seat 120 may be molded together as one continuous unit generally representing a toilet bowl having a toilet seat 120.

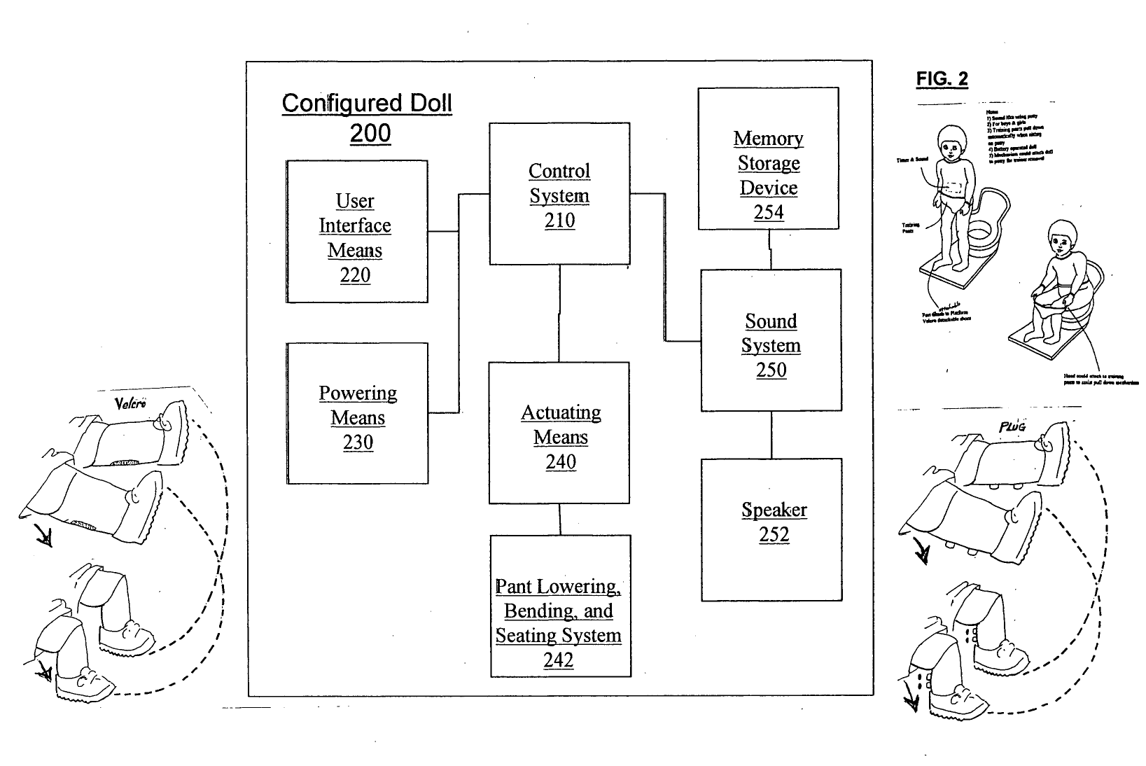

FIG. 2 provides drawings and a block diagram of a configured doll 200. The configured doll 200 comprises a control system 210 having a user interface means 220, a powering means 230, an actuating means 240, and a sound system 250. The actuating means 240 further comprises a pant lowering, bending, and seating system 242. Similarly, the sound system 250 further comprises a speaker 252 and a memory storage device 254.

In a preferred embodiment, the configured doll 200 has a control system 210 comprising the powering means 230 and capable of receiving a control signal from the user interface means 220. The control signal is any means that facilitates the transfer of a data element or electrical current from one system component to another, or other means as apparent to those skilled in the art of articulating toys utilizing electronic circuitry. Once the control system 220 receives a control signal from the user interface means 120 the control system 210 passes the control signal to the actuating means 240 whereby the actuating means 240 manipulates an electrical motor or solenoid and activates the pant raising, lowering, an seating system 242. Furthermore, the sound system 250 plays a digital sound stored in the memory storage device 254 through at least one speaker 252 once the control signal is received from the control system 210. Sounds may include a toilet flushing, a song, or a child laughing, for example.

Preferably, the user interface means 220 is locally activated via at least one electrical switch that initiates the control system 210 to transmit a control signal to the actuating means 240 whereby the pant lowering, bending, and seating system 242 such that operation commences. In an alternative embodiment, the user interface means 220 may be remotely activated via radio wave signals, such as radio frequency (RF) or infra-red (IrDA), for example. In yet another embodiment, the user interface means 220 may be remotely activated via a human voice, or specific human voice commands, such as “potty time”, for example.

It is apparent to those skilled in the art of toy or doll design and manufacturing that the user interface means 220 may implemented as a single electronic switch or a multifunction electronic switch that is manipulated by a user. In addition, it is also apparent that in more complex embodiments the user interface means 220 may be embodied as a touch screen liquid crystal display (LCD) having a list of control system 210 capabilities to select from, such as “potty time”, “flush toilet”, “pull up pants”, play a nursery rhyme, or to have the doll talk, for example.

The powering means 230, in one embodiment, is at least one battery. Preferably, an alkaline battery is used; however, alternatively other types of batteries such as Nickel Cadmium and Lithium Ion may be used. In an alternative embodiment, alternative current (AC) may be used whereby a power cable is necessary to transfer power from the AC source to the configure doll 200. In yet another embodiment, kinetic energy may be stored when the doll moves or is shaken. The stored kinetic energy may then be used to power the control system 210 and its corresponding components.

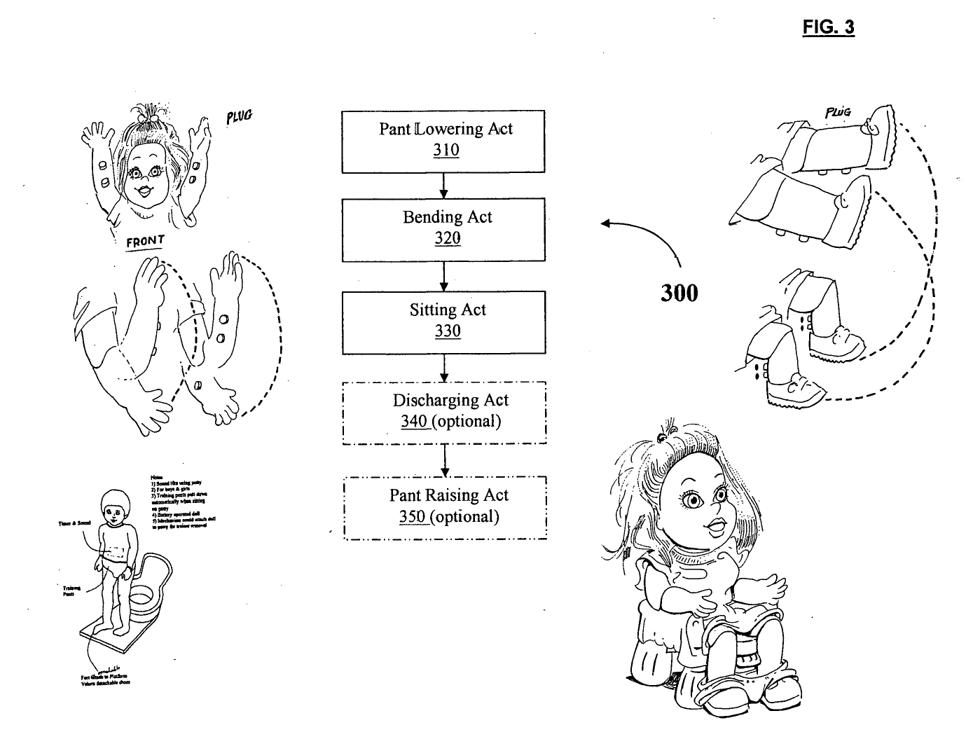

FIG. 3 illustrates drawings and a block diagram of a configured doll pant lowering, bending, and seating method 300. In a preferred embodiment, the method 300 enables the configure doll to simulate the behavior of a potty training toddler at least comprising a pant lowering act 310, a bending act 320, and a sitting act 330. In alternative embodiments, the method 300 may also comprise, in addition to the previously mentioned acts, a discharging act 340 (optional) and a raising pant act 350 (optional).

In a preferred embodiment, the control signal is received by the actuating means 240 from the control system 210 whereby the pant lowering, bending, and seating system 242 operation is commenced thereby initiating the pant lowering, bending, and seating method 300. The method 300 enables the configured doll to simulate the behavior of a toilet training toddler by first lowering the configured doll's under garment preferably, from the doll's waist portion to the doll's lowermost leg portion (ankle), through a pant lowering act 310. Once this has been accomplished, the configured doll is manipulated from a standing position to a bent knee position via a bending act 320 such to ready the configured doll to sit onto the toilet seat. Once the doll has been readied for sitting on the toilet seat, the configure doll is then seated on the toilet seat via a sitting act 330.

Others skilled in the art of designing and manufacturing toys may recognize that mechanically a track or-pathway may be utilized to lower the doll's under pant garment from the doll's waist portion to the doll's lowermost leg portion. In addition, it is apparent that at least one flexible joint is necessary per leg to manipulate the configured doll from a standing position to a bent knee position. Furthermore, once seated the configured doll rests its rear end on the toilet seat similarly as a toddler rests its rear end on a toilet.

A discharging act 340 may be embodied in an alternative iteration of the toilet training doll device. The discharging act 340 simulates a toddler eliminating the contents of his or her bladder within the toilet. Preferably, the discharging act 340 occurs after the sitting act 330. In addition, a flush sound may be played by the sound system once the discharging act 340 is complete.

It is also apparent to those skilled in the art that the acts described above may overlap and is dependent on the implementation in the pant lowering, bending, and seating system. In addition, each act may have may be operated by a timer having an exact start and end point. Furthermore, the configured doll may comprise a chamber that is enabled to store liquid such that when the discharging act 340 is activated the liquid is discharge from the chamber thus simulating a toddler discharging urine.

Thus, though the invention has been described with respect to a specific preferred embodiment, many variations and modifications will become apparent to those skilled in the art upon reading the present application. It is therefore the intention that the appended claims be interpreted as broadly as possible in view of the prior art to include all such variations and modifications.

1. A toilet training doll system, the system comprising:
a configured doll having a control system; and
a toilet seat.

2. The toilet training doll system of claim 1 wherein the control system comprises:
a configured doll having a control system comprising a powering means and capable of receiving a control signal from a user interface means;
the control system capable of passing the control signal to an actuating means enabling a pant lowering, bending, and seating system; and
the control system capable of passing the control signal to a sound system having a memory storage device and a speaker.

3. The toilet training doll system of claim 2 wherein the user interface means is locally activated via at least one electrical switch initiating the control system to transmit the control signal to the actuating means whereby the pant lowering, bending, and seating system operation commences.

4. The toilet training doll system of claim 2 wherein the user interface means is remotely activated via a radio wave signal.

5. The toilet training doll system of claim 2 wherein the user interface means is remotely activated via a human voice.

6. The toilet training doll system of claim 2 wherein the powering means is kinetic energy.

7. The toilet training doll system of claim 2 wherein the pant raising, lowering and seating system having a method, the pant lowering, bending, and seating method comprising:
a pant lowering act;
a bending act; and
a sitting act.

8. A toilet training doll system, the system comprising:
a configured doll having a control system comprising a powering means and capable of receiving a control signal from a user interface means;
the control system capable of passing the control signal to an actuating means enabling a pant lowering, bending, and seating system; and
the control system capable of passing the control signal to a sound system having a memory storage device and a speaker; and
a toilet seat, whereby, the pant lowering, bending, and seating system operates according to a method that enables the configured doll to simulate the behavior a potty training toddler, the pant lowering, bending, and seating system method comprising:
a pant lowering act;
a bending act; and
a sitting act.

9. The toilet training doll system of claim 8 wherein the toilet seat is sized for the configured doll.

10. The toilet training doll system of claim-8 wherein the toilet seat is sized for a toddler.

11. The toilet training doll system of claim 8 wherein the configured doll is adapted to removably attach to a portion of the toilet seat via a fastening means.

12. The toilet training doll system of claim 8 wherein the sound system plays a generally toilet flushing like sound when a control signal is received from the control system.

13. The toilet training doll system of claim 8 wherein the sound system plays a generally toilet flushing sound once the configured doll has completed the sitting act.

14. The toilet training doll system of claim 8 wherein the pant lowering, bending, and seating method is followed by a discharging act.

15. The toilet training doll system of claim 8 wherein the pant lowering, bending, and seating method is followed by a pant raising act.

16. A toilet training doll device having a control system comprising:
a configured doll having a control system comprising a powering means and capable of receiving a control signal from a user interface means;
the control system capable of passing the control signal to an actuating means enabling a pant lowering, bending, and seating system; and
the control system capable of passing the control signal to a sound system having a memory storage device and a speaker.

17. The toilet training doll device of claim 16 wherein the pant raising, lowering, and seating system operates according to a method that enables the configured doll to simulate the behavior a potty training toddler having a method, the pant lowering, bending, and seating method comprising:
a pant lowering act,
a bending act; and
a sitting act.

18. The toilet training doll device of claim 17 wherein the pant lowering, bending, and seating method is followed by a discharging act and a pant raising act.

19. The toilet training doll device of claim 16 wherein the actuating means is an electrical motor that is manipulated once a control signal is received from the control system activating the pant lowering, bending, and seating method.

20. The toilet training doll device of claim 16 wherein the sound systems plays a digital sound stored in the memory storage device through a least one speaker once a control signal is received from the control system.
